(19) United States
(12) Patent Application Publication
(10) Pub. No.: US 2007/0078879 A1
(43) Pub. Date: Apr. 5, 2007

(54) Active address table

(76) Inventors: Robert J. Safranek, Portland, OR (US); Aimee D. Wood, Tigard, OR (US); Herbert H.J. Hum, Portland, OR (US); Robert H. Beers, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/240,977

(22) Filed: Sep. 30, 2005

(51) Int. Cl. G06F 7/00

(52) U.S. Cl. 707/102

(57) ABSTRACT

A structure referred to as an Active Address Table (AAT) may be used for cache coherence conflict resolution. The AAT may function to detect conflicting coherent requests to the same address and may ensure that each requesting entity receives a copy of the requested cache line in a cache line state-maintaining manner.

### TECHNICAL FIELD

Embodiments of the invention relate to cache coherency protocols. More particularly, embodiments of the invention relate to conflict resolution techniques that may be use with cache coherency protocols.

### BACKGROUND

As the number of cache memories in a complex system increases, so too does the latency associated with checking the cache memories for a valid, or most recent, copy of requested data. This is a result of a typically hierarchical memory structure, which requires that the request be transmitted through multiple layers of the memory structure.

For example, if a processor or a memory controller broadcasts a request for a copy of a block of data (e.g., a cache line), each cache memory in the system receives the request and checks for the requested data. Each cache memory must also respond to the source of the request. This request-response protocol can be very bandwidth intensive in complex systems.

One technique that has been used in these complex systems is a directory that tracks the location of the valid copy of the requested data. A single, centralized directory can be used. Use of a centralized directory quickly increases the complexity and bandwidth requirements for a system because every transaction must be reflected by the directory. Thus, the directory must be checked and/or updated for each request and each response even if the directory does not provide any relevant information related to the request or response. However, the centralized directory can become a bottleneck to performance as the complexity of the system increases because many devices must search the directory for each request for data.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of one embodiment of an electronic system having one an active address table.

FIG. 2 is a block diagram of one embodiment of a system component having an active address table.

FIG. 3 is a state diagram corresponding to one embodiment of a state machine that may be used for conflict resolution in a system having an active address table.

FIG. 4a is a block diagram of one embodiment of electronic system having a processor core, a memory controller and a memory that may use a point-to-point interface in which an active address table may be used.

FIG. 4b is a block diagram of one embodiment of electronic system having a processor core, a memory and an I/O controller hub that may use a point-to-point interface in which an active address table may be used.

FIG. 4c is a block diagram of one embodiment of electronic system having an I/O controller hub coupled with two processor cores each having a memory that may use a point-to-point interface in which an active address table may be used.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

Described herein is a structure referred to as an Active Address Table (AAT) that may be used for cache coherence conflict resolution. In one embodiment, the AAT. may function to detect conflicting coherent requests to the same address and may ensure that each requesting entity receives a copy of the requested cache line in a cache line state-maintaining manner. The architecture described herein may be particularly useful for single or dual processor systems in which efficient, low-latency execution of operations is desirable.

The techniques described herein include a snooping protocol without the limitations of a single, serializing bus. In one embodiment, point-to-point links rather than synchronous, centralized broadcasts may be used for cache coherency purposes. As described in greater detail below home nodes and/or home agents may be used to support conflict resolution for cache coherency purposes. A Home node may have non-cache memory to store an uncached copy of a block of data. In one embodiment, the Home node may participate in every transaction—without being on the critical path—in order to resolve conflicts and time-warp issues.

In one embodiment, the AAT may track every coherent address that has an active request being processed by the home agent. Thus, an active address is defined as one having one or more Home Tracker (HT) entries currently tracking a coherent request to that address. As described in greater detail below, HT entries may provide a mechanism to resolve cache line conflicts. In one embodiment, when more than one HT entry tracks a coherent request to the same address, those requests and HT entries are said to be conflicting. In one embodiment, the AAT may detect conflicts and may resolve the conflicts using conflict resolution rules.

As described in greater detail below, as requests, snoop responses, and acknowledgements arrive at the home agent, they may be recorded in the Home Tracker and processed by the AAT. In one embodiment, each AAT entry tracks a single active address and maintains state information for conflict-resolution in accordance with cache coherence specifications. Addresses and HT entries may be assigned to AAT entries as address-bearing messages arrive at the home agent, thus ensuring all messages involving requests to the same address are processed by the same AAT entry.

In one embodiment, each AAT entry (1) tracks progress of a corresponding request to determine when request is allowed to end the Request phase; (2) records the current owner of the cache line and prevents other requests from obtaining ownership prematurely; (3) processes conflict acknowledgements from requests; and (4) detects when the owner has already processed other requests' snoops and directs the owner to explicitly forward the cache line to the next owner (as selected by the AAT entry).

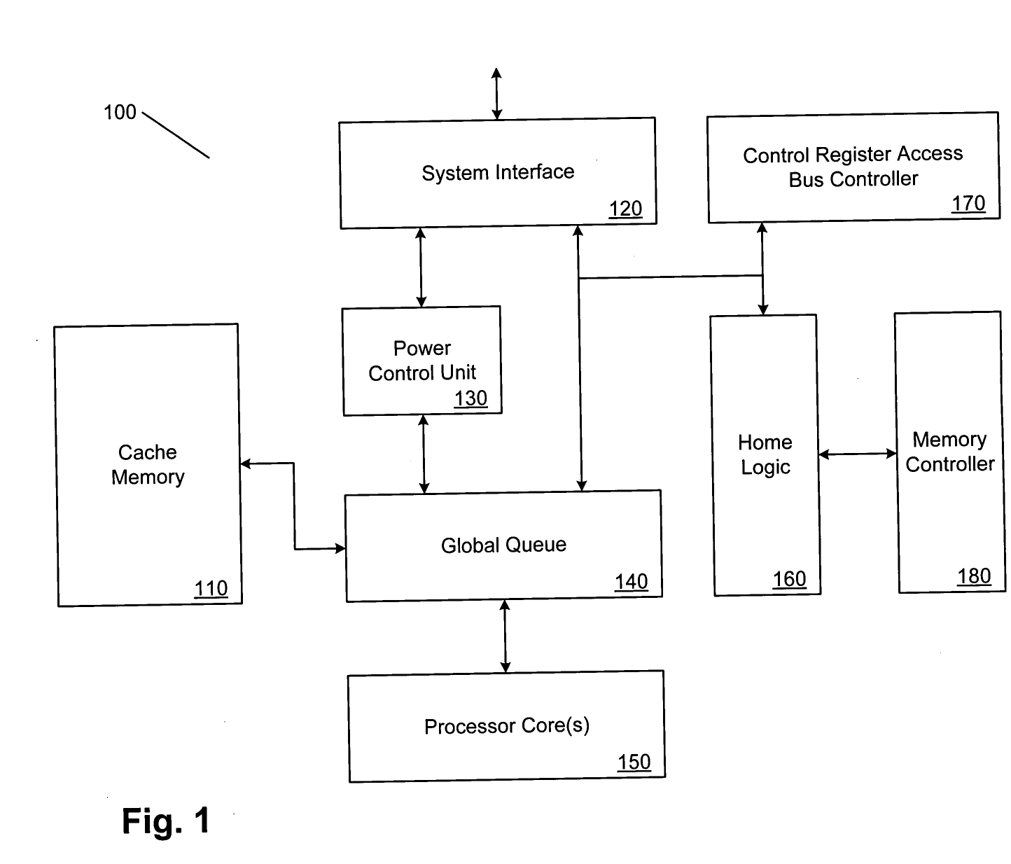

FIG. 1 is a block diagram of one embodiment of an electronic system having one an active address table. Electronic system 100 is intended to represent a broad variety of electronic systems. Several example configurations are described in greater detail below.

Electronic system 100 may include processor core(s) 150, which may represent one or more processor cores. In general, a processor core is a portion of an integrated circuit that provides processing functionality. Processor core(s) 150 may be coupled with global queue 140 that may function to stage data passing to and from processor core(s) 150.

In one embodiment, global queue 140 may be coupled with cache memory 110, which may be any type of cache memory. In one embodiment, cache memory 110 is a last level (or highest level) cache memory. Lower level cache memories may be included, for example, within one or more of processor core(s) 150 and/or coupled with one or more of processor core(s) 150 (not illustrated in FIG. 1).

In one embodiment, global queue 140 may be coupled with power control unit 130 and with system interface 120. Power control unit 130 may provide power control functionality and is not required to implement the active address table. System interface 120 may provide an interface between an integrated circuit package having the components of electronic system 100 and external devices (not illustrated in FIG. 1).

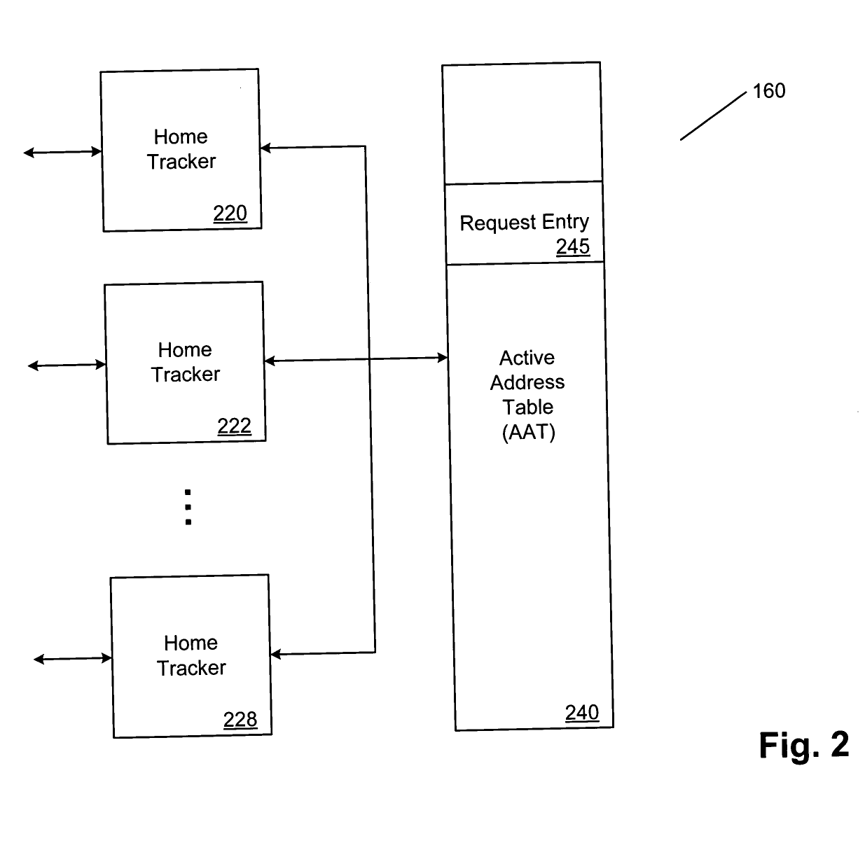

In one embodiment, system interface 120 may include physical layer and link layer functionality that may allow electrical signals to be received via system interface 120 to be processed by components of electronic system 100. For example, system interface 120 may be a serial point-to-point interface. In one embodiment, system interface 120 and global queue 140 may be coupled with control register access bus controller 170 and home logic 160. In one embodiment home logic 160 (described in greater detail with respect to FIG. 2) may include the active address table and other control logic. Home logic 160 may be coupled with memory controller 180, which may be coupled with memory devices (not illustrated in FIG. 1).

FIG. 2 is a block diagram of one embodiment of a system component having an active address table. In one embodiment, home logic 160 includes one home tracker (e.g., 220, 222, . . . 228) for each point-to-point interface (not illustrated in FIG. 2) supported by home logic 160. The example of FIG. 2 includes three home trackers; however, any number of home trackers may be supported. Each home tracker may be coupled with active address table (AAT) 240. The home trackers may be coupled directly to AAT 240, or the home trackers may be coupled with AAT 240 via a shared bus or other multiplexed interface.

In one embodiment AAT 240 may contain 56 entries; however, any number of entries can be supported. The total number of entries in the multiple home trackers may be equal to the number of entries in AAT 240. In one embodiment, all HT entries containing a valid coherent address may be linked to a corresponding AAT entry (e.g., request entry 245). Each unique address may be linked to a unique AAT ID. If entries in two or more home trackers conflict by containing requests to the same address, the conflicting entries may be assigned the same AAT ID. The AAT entry may be used to coordinate conflict resolution required between two (or more) requests. In one embodiment, AAT 240 may link HT entries with the same address together but may not store that address separately in its own fields.

In one embodiment, each AAD entry (e.g., request entry 245) may include the following fields.

TABLE 1
Example AAT Entry Fields

| Field Name | Bits | Description |
|---|---|---|
| AatFsm | 3 | Master state machine for conflict resolution |
| Owner | 2 | Data owner, if known, for the corresponding line |
| ValReq | 3 | Request valid bit for each link |
| TrueCnfltC | 2 | Another link is a potential true conflictor to the |
| | | chipset link's request |
| TrueCnfltS | 2 | Another link is a potential true conflictor to the |
| | | sibling link's request |
| TrueCnfltL | 2 | Another link is a potential true conflictor to the local |
| | | link's request |
| ValHTId | 3 | HT ID valid bit for each link |
| HTIdC | 5 | Home Tracker ID for the chipset link |
| HTIdS | 5 | Home Tracker ID for the sibling link |
| HTIdL | 5 | Home Tracker ID for the local link |

In alternate embodiments, a different number of fields and/or different fields may also be supported. In one embodiment, the AAT fields may be set or updated in response to a message from a home tracker entry. The fields corresponding to an entry may be all cleared together when AAT 240 sends a Complete message to one or more home trackers corresponding to the entry, indicating that the AAT portion of any conflict has been resolved for the corresponding entry.

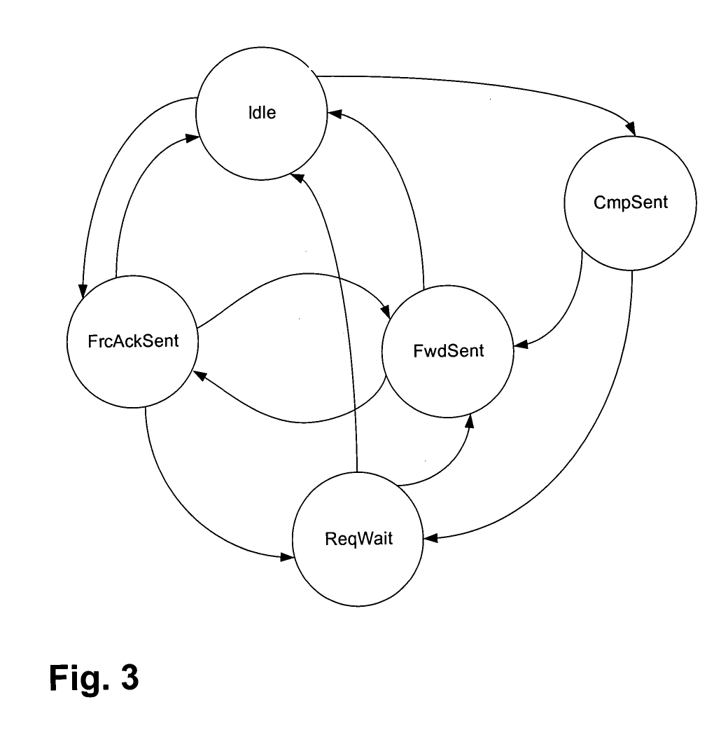

In one embodiment, the AatFsm field is used to track the progress of conflict resolution. An entry having no conflict between allocation and completion may not leave the Idle state of the conflict resolution state machine. An entry having a conflict, however, will sequence through multiple conflict resolution states until the conflict is resolved. One embodiment of the conflict resolution state machine is described in greater detail below with respect to FIG. 3.

In one embodiment, the Owner field is used to track ownership of the data corresponding to a given address. The Owner field may be updated when AAT control logic can determine which agent owns data, either through home tracker notification (such as the receipt of a RspFwd message) or through AAT actions (such as requesting one agent to forward data to another). More detail with respect to the points at which the AAT updates its Owner field are included in the section on conflict resolution mechanisms.

In one embodiment, each AAT entry may have three ValReq bits, corresponding to each of the three home trackers. In alternate embodiments, other bit configurations may be used. In one embodiment, the ValReq bit for a corresponding home tracker may be set when the home tracker sends a HTMsgReq message, indicating that the read or write request message has been received. The ValReq bit may be cleared when a AatCmpl message is sent to the corresponding home tracker. In one embodiment, the tracking and conflict resolution protocol require that a given agent issue only one coherent request per address.

In one embodiment, each entry may contain six TrueCnflt bits. In alternate embodiments, a different number of TrueCnflt bits may be used. These bits may be used to track which request source (or link) has sent snoop responses to other requests. In one embodiment, the TrueCnfltXY bit may be set when the HTRcvdRspX signal is asserted from home tracker Y. For example, when one link corresponds to a chipset, the TrueCnfltCS may be set when a sibling link tracker entry sends HTRcvdRspC, indicating that the home tracker entry has received a snoop response from the chipset link. One embodiment of the six TrueCnflt bits and their meaning are summarized in Table 3 when the three links supported correspond to a local link (e.g., a local processing core), a sibling link (e.g., a second processing core) and a chipset. Other components and/or devices may have corresponding links.

TABLE 3
Example TrueCnflt Bits

| TrueCnflt Bit | Meaning |
|---|---|
| TrueCnfltCS | Linked HTIdS has received a snoop response from the |
| | chipset link |
| TrueCnfltCL | Linked HTIdL has received a snoop response from the |
| | chipset link |
| TrueCnfltSC | Linked HTIdC has received a snoop response from the |
| | sibling link |
| TrueCnfltSL | Linked HTIdL has received a snoop response from the |
| | sibling link |
| TrueCnfltLC | Linked HTIdC has received a snoop response from the |
| | local link |
| TrueCnfltLS | Linked HTIdS has received a snoop response from the |
| | local link |

In one embodiment, TrueCnflt bits may be cleared when the AAT sends AatCmpl to a tracker entry. When this clearing condition occurs, the TrueCnflt*Y bits are cleared, where Y is the tracker that is being completed. That these cleared bits are the same bits that were set earlier by messages from tracker Y. The TrueCnflt bits may be used to affect AatFsm state updates, as well as to determine which other link, if any, a requesting entry should forward to.

Some AAT state transitions may require the AAT to determine information about true conflictors. Given a specific link, the AAT logic may in some cases determine both whether another specific link is a true conflictor to the given link, and whether any link is a true conflictor to the given link. Determining the first piece of information may include checking the corresponding TrueCnflt bit. For example, given LinkC, LinkS is known to be a true conflictor to LinkC if TrueCnfltCS is asserted. Determining the second piece of information may include ORing together two of the TrueCnflt bits. For example, given LinkC, LinkC is known to have some true conflictor if either TrueCnfltCS or TrueCnfltCL is asserted.

In one embodiment, the home tracker ID for each link may be stored in the AAT entry for use as an index when sending messages back to a home tracker, and to pass along with forward messages. The ValHTId bit may be set and the corresponding home tracker ID field may be updated when any valid message is received from a link whose VaIHTId bit is not yet asserted. ValIHTId may be cleared when AatCmpl is sent to the corresponding home tracker.

In one embodiment, when the AAT sends AatCmpl to a home tracker entry, the AAT may clear all fields related to that entry. This clear results in the ValReq, and ValHTId bits for the entry's link being set to zero. The TrueCnflt bits associated with the link may also cleared. TrueCnfltXY bits are written by agent Y, so for example a Complete sent to an entry in the chipset link clears TrueCnfltSC and TrueCnfltLC.

Entries in the AAT may be managed using any technique known in the art. In one embodiment, AAT control logic may manage a freelist of AAT IDs. At reset, all IDs may be included in the freelist, and ID 0 is made available to the home trackers via an AatNextId interface. Each assertion of HTPopAatId removes the current AatNextId from the freelist and moves the next ID on the list to the interface. The final home tracker complete message sent from the AAT for a given AAT entry adds the ID back to the freelist. In one embodiment, the ReleaseAat bit corresponding to a given AAT entry may be asserted in response to certain AatFsm transitions, to indicate that the AAT entry is ready to be deallocated.

In one embodiment, the following interface by be provided between the AAT and the home trackers. The AAT may interface with the home trackers in order to receive information on potential conflicts and to send conflict resolution messages to the home tracker entries. Error! Reference source not found and Error! Reference source not found list one embodiment of interface signals between the home trackers and the AAT structure. In alternate embodiments, a different set of signals may be supported.

TABLE 3
Example Home Tracker to AAT interface signals

| Signal name | Bits | Description |
|---|---|---|
| HTVal | 1 | Valid bit for the HT message |
| HTAatId | 6 | AAT entry being addressed |
| HTSenderId | 7 | Link and entry IDs of the HT sending |
| | | the message |
| HTPopAatId | 1 | AatNextId was consumed and must be |
| | | updated |
| HTRcvdRsp[C, | 3 | Sending HT has received snoop responses |
| S, L] | | from the indicated links |
| HTRcvdAllMsg | 1 | Sending HT received all expected messages |
| HTMsgRspCnflt[C, | 1 | Sending HT received a RspCnflt from the |
| S, L] | | indicated link |
| HTMsgReq | 1 | Sending HT received its request message |
| HTMsgRspFwd | 1 | Sending HT received a RspFwd |
| HTMsg2ndRsp | 1 | Sending HT received a second response from |
| | | the same link |
| HTMsgAckCnflt | 1 | Sending HT received an AckCnflt |
| HTMsgWb | 1 | Sending HT received a write request or |
| | | writeback snoop response |

TABLE 4
Example AAT to Home Tracker interface signals

| Signal name | Bits | Description |
|---|---|---|
| AatVal | 1 | Valid bit for the AAT message |
| AatHTId | 7 | Link and entry ID of the HT being |
| | | addressed |
| AatMsg | 2 | Encoded AAT message (see Error! |
| | | Reference source not found.) |
| AatFwdId | 7 | Link and entry ID for recipient of |
| | | forwarded data |
| AatNextId | 6 | Next AAT ID to be taken from the AAT |
| | | freelist |

In one embodiment, the AatMsg signal may provide information about the type of message the AAT is indicating may be sent from the home tracker entry, one example of which is described in the table below. The receiving home tracker entry may combine AATMsg with information stored in the entry to generate an outgoing message to the original requestor.

TABLE 5
Example AATMsg encodings

| AATMsg Value | Requested CSI Message |
|---|---|
| 00 | None (implies conflict resolution is in progress) |
| 01 | FrcAckCnflt |
| 10 | Complete |
| 11 | Complete Forward |

In one embodiment, the MSB of AatMsg, if set, indicates that the home tracker entry can deallocate after sending the message (which is a type of complete). This bit (when asserted with AatVal) is therefore renamed to AatCmpl, where it is used for various field updates in the AAT and home tracker entries that occur as an entry is nearing completion and deallocation.

FIG. 3 is a state diagram corresponding to one embodiment of a state machine that may be used for conflict resolution in a system having an active address table. Conflicts occur when two or more coherent requests attempt to access the same cache line. Although conflicts may be rare, when they do occur the AAT may be used to ensure that all requesting agents and memory are provided with correct data. In one embodiment, coherent traffic is required to maintain coherency by ordering all requests to a given cache line. This ordering may be handled according to the conflict resolution protocol explained in more detail below.

A conflict occurs when multiple coherent requests are made to the same address. In one embodiment, the coherency protocol forbids more than one coherent request to a given cache line from being issued by each link. Thus, when three links are supported, at most three conflicting requests (one per home tracker) can exist at any given time. In alternate embodiments, a different number of links may be supported.

In one embodiment, all incoming messages that contain an address may be compared against all other addresses stored in the home trackers. One of the purposes of the Active Address Table is to ensure that all coherent requests to the same address are found and any conflicts are resolved. In one embodiment, each coherent request home tracker entry is linked to a corresponding AAT entry, and all requests to the same address are linked to the same AAT entry.

In general, the result of conflict resolution is to ensure that each requesting link, in turn, is provided access to the requested data. Each valid AAT entry may be used to monitor traffic for a currently active address. When only a single home tracker entry exists for an address, the AAT detects that only a single home tracker has linked itself to an AAT entry. Once the home tracker entry has received all of the corresponding incoming messages, the AAT may confirm that there is no conflict and may send a complete message, allowing the home tracker entry to be used to generate complete message and to deallocate the home tracker entry.

In the event that a conflict occurs, an AAT entry will have two or more links with ValHTId bits set. In this situation, when one of the corresponding home tracker entries has received all of the corresponding incoming messages, the AAT does not allow the request to complete as described above. Instead, the AAT may send a conflict resolution message to the home tracker, indicating that a conflict has been detected. The AAT may control the process of determining which messages will be sent and sampled in order to resolve the conflict for all involved home tracker entries.

The conflict resolution process may be complex, with multiple messages potentially being sent from and received by the home trackers. Further complexity may result from the potential for the conflicting entries to occur in many different orders. FIG. 3 and the following description provide details of an example state machine and corresponding states, state transitions, and interface messages.

In one embodiment, once a conflict has been detected, AAT control logic may determine which messages should be generated and sent. The AAT control logic may also monitor incoming messages via signals asserted by the home trackers, and update corresponding entries and/or state transitions as conflict resolution progresses.

Some home tracker messages may result in AAT state updates, independent of the AatFsm state. The table below describes one example of how these incoming signals may affect the AAT fields.

TABLE 6
Example AAT General State Update

| Input from HT | Outputs |
|---|---|
| HTVal | If ˜ValHTId, set ValHTId and HTId fields from |
| | HTSenderId |
| HTPopAatId | Pop the freelist and update AatNextId |
| HTMsgReq | Set ValReq for sending HT |
| HTRcvdRsp* | Update TrueCnflt bit(s) |
| HTMsgRspFwd | Set Owner to sending HT |
| HTRcvdAllMsg | Set AllMsgRcvd for sending HT |
| HTMsgWb | Set Owner to sending HT |

Referring now to FIG. 3, in one embodiment, the AAT remains in the Idle state when there are no conflicts. The following table provides one embodiment of state transitions from the Idle state.

TABLE 8
Idle state transitions

| | Next | |
|---|---|---|
| Inputs | State | Outputs |
| ((HTRcvdAllMSg & | Idle | Set Owner = None. Clear sender's |
| ˜HTMsgRspCnflt) \| | | AAT fields. Send AatMsg=Cmp to |
| HTMsgAckCnflt) & (All other | | sender. Assert AatRelease. |
| entry ValHTId == 0) | | |
| HTRcvdAllMsg & (Owner == other | Idle | Send AatMsg = None to sender. |
| link) | | |
| HTMsgRspCnflt & (Conflictor | CmpSent | Set Owner = conflictor. If |
| entry ValReq == 0) | | HTRcvdAllMsg, send AatMsg = None |
| | | to sender. |
| HTRcvdAllMsg & (Owner == None | FrcAckSent | Set Owner = sender. Send |
| \| Owner == sender) & (Some other | | AatMsg = FrcAckCnflt to sender. |
| entry ValHTId == 1) | | |

In one embodiment, the AAT may wait in the CmpSent state until a conflicting home tracker entry, which has already been sent a Complete message, returns a AckCnflt message. The following table provides one embodiment of state transitions from the CmpSent state.

TABLE 9
CompSent state transitions

| | Next | |
|---|---|---|
| Inputs | State | Outputs |
| HTRcvdAllMsg & | CmpSent | Send AatMsg = None to sender. |
| (Owner == | | |
| other link) | | |
| HTMsgAckCnflt & | FwdSent | Set Owner = some TC. Clear |
| (Some other | | sender's AAT fields. Send |
| entry ValReq == 1) | | AatMsg = CmpFwd (to TC) to |
| | | sender. |
| HTMsgAckCnflt & | ReqWait | Send AatMsg = None to sender. |
| (All other entry | | |
| ValReq == 0) | | |

In one embodiment, the AAT may enter the FrcAckSent state as a FrcAckCnflt message is sent to a home tracker, after which the AAT may wait to receive the requested AckCnflt message. The following table provides one embodiment of state transitions from the FrcAckSent state.

TABLE 10
FrcAckSent state transitions

| Inputs | Next State | Outputs |
|---|---|---|
| HTRcvdAllMsg | FrcAckSent | Send AatMsg = None to |
| | | sender. |
| HTMsgAckCnflt & | Idle | Set Owner = None. Clear |
| (All other entry | | sender's AAT fields. Send |
| ValHTId == 0) | | AatMsg = Cmp to sender. |
| | | Assert AatRelease. |
| HTMsgAckCnflt & (Some | Idle | Set Owner = None. Clear |
| other entry ValReq == 1 | | sender's AAT fields. Send |
| and is not TC) | | AatMsg = Cmp to sender. |
| HTMsgAckCnflt & (Some | FwdSent | Set Owner = TC. Clear |
| other entry ValReq == 1 | | sender's AAT fields. Send |
| and is TC) | | AatMsg = CmpFwd |
| | | s (to TC) to ender. |
| HTMsgAckCnflt & | ReqWait | Send AatMsg = None to |
| (Some other entry | | sender. |
| ValHTId == 1) & (All other | | |
| entry ValReq == 0) | | |

In one embodiment, the AAT may enter the FwdSent state as a CmpFwd message is sent to a home tracker, after which the AAT may wait for the forwardee to receive a second response message from the forwarding link. The following table provides one embodiment of state transitions from the FwdSent state.

TABLE 11
FwdSent state transitions

| Inputs | Next State | Outputs |
|---|---|---|
| HTRcvdAllMsg & (Owner == other link \| | FwdSent | Send |
| (Owner == sender & ˜HTMsg2ndRsp)) | | AatMsg = |
| | | None |
| | | to sender. |
| HTMsg2ndRsp & (Owner == sender) & | Idle | None |
| ˜AllMsgRcvd | | |
| HTMsg2ndRsp & (Owner == sender) & | FrcAckSent | Send |
| AllMsgRcvd | | AatMsg = |
| | | FrcAckCNflt |
| | | to |
| | | sender. |

In one embodiment, the AAT may enter the ReqWait state when one home tracker is ready to complete, but the completion cannot be allowed because the corresponding entry contains the only valid copy of the AAT entry address. The AAT may wait in the ReqWait state until an incoming request message provides a second copy of the address. The following table provides one embodiment of state transitions from the ReqWait state.

TABLE 12
ReqWait state transitions

| Inputs | Next State | Outputs |
|---|---|---|
| HTMsgReq & (Owner entry | ReqWait | None |
| has TC but it is not sender) | | |
| HTMsgReq & (Owner entry | Idle | Set Owner=None. Clear |
| has no TC) | | current owner's AAT fields. |
| | | Send AatMsg=Cmp |
| | | to current owner. |
| HTMsgReq & (Sender is TC | FwdSent | Set Owner=sender. Clear |
| to Owner) | | current owner's AAT fields. |
| | | Send AatMsg=CmpFwd (to |
| | | sender) to current owner. |

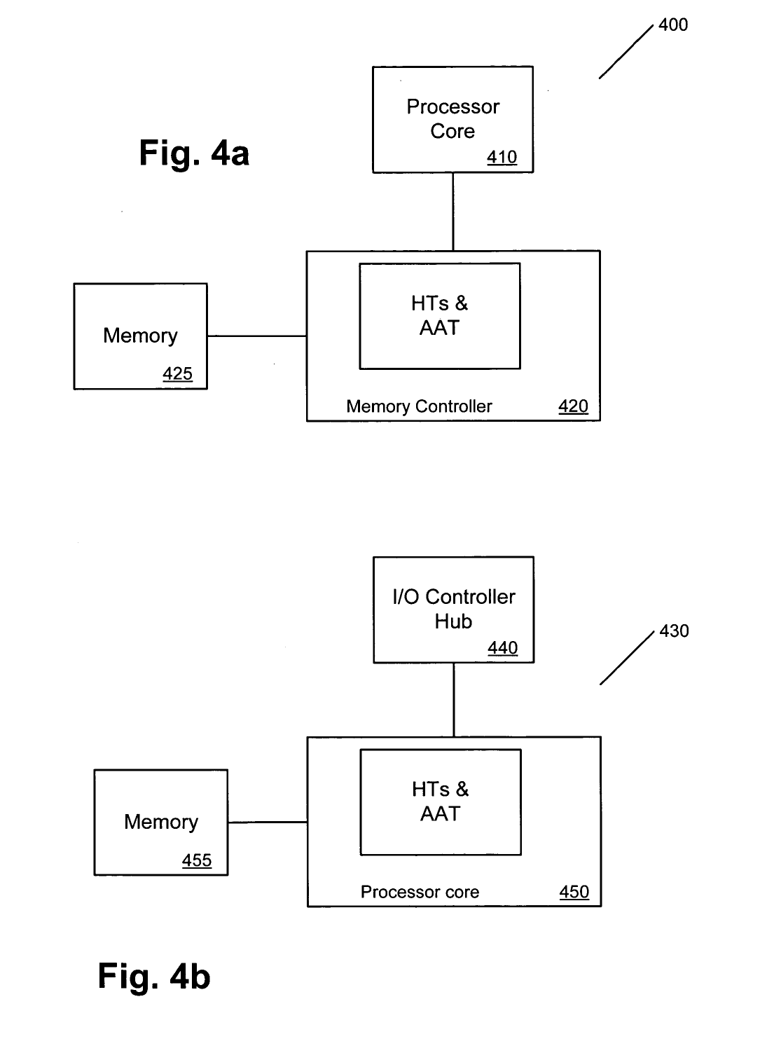

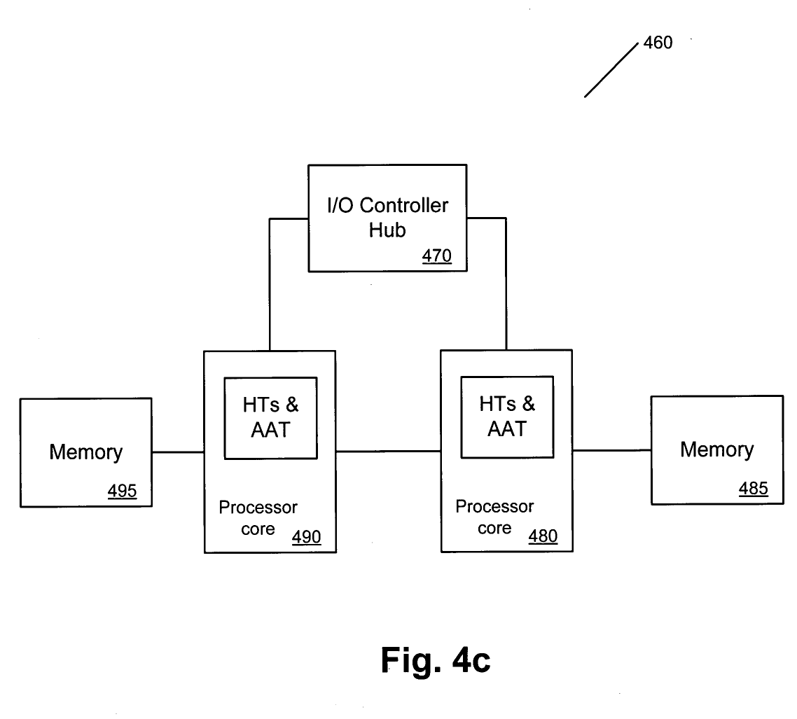

FIG. 4a is a block diagram of one embodiment of electronic system having a processor core, a memory controller and a memory that may use a point-to-point interface in which an active address table may be used. Additional components not illustrated in FIG. 4a may also be supported.

Electronic system 400 may include processor core 410 and memory controller 420 that are coupled together with a point-to-point interface as described above. Memory controller 420 may also be coupled with memory 425, which may be any type of memory including, for example, random access memory (RAM) of any type (e.g., DRAM, SRAM, DDRAM). In one embodiment, memory controller 420 may include home trackers and an active address table that may function as described above.

FIG. 4b is a block diagram of one embodiment of electronic system having a processor core, a memory and an I/O controller hub that may use a point-to-point interface in which an active address table may be used. Additional components not illustrated in FIG. 4a may also be supported.

Electronic system 430 may include processor core 450 and I/O controller hub 440 that are coupled together with a point-to-point interface as described above. Processor core 450 may also be coupled with memory 455, which may be any type of memory including, for example, random access memory (RAM) of any type (e.g., DRAM, SRAM, DDRAM). In one embodiment, processor core 450 may include home trackers and an active address table that may function as described above.

FIG. 4c is a block diagram of one embodiment of electronic system having an I/O controller hub coupled with two processor cores each having a memory that may use a point-to-point interface in which an active address table may be used. Additional components not illustrated in FIG. 4a may also be supported.

Electronic system 460 may include two processor cores 480, 490 and I/O controller hub 470 that are coupled together with point-to-point interfaces as described above. Processor cores 480, 490 may also be coupled with memories 485, 495, which may be any type of memory including, for example, random access memory (RAM) of any type (e.g., DRAM, SRAM, DDRAM). In one embodiment processor cores 480 and 490 may have home trackers and active address tables that function as described above.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
generating an entry in a first tracking structure in response to detecting a request for data received via a first point-to-point interface, wherein each point-to-point interface connection has a corresponding tracking structure;
generating, for each entry in the tracking structure a corresponding entry in a table, wherein each entry in each tracking structure corresponds to an entry in the table and further wherein entries in the table determine whether conflicting requests have been received; and
resolving conflicting requests according to a cache coherency protocol when conflicting requests have been detected.

2. The method of claim 1 wherein the table comprises an active address table that is associated with a memory to store a non-cached block of data associated with an address within a range corresponding to the memory.

3. The method of claim 2 wherein resolving the conflicting requests according to the cache coherency protocol comprises monitoring messages associated with the conflicting requests via the active address table until the conflicting requests have been resolved.

4. The method of claim 1 wherein generating an entry in the first tracking structure in response to detecting the request for data received via a point-to-point interface comprises:
receiving the request via the first point-to-point interface;
comparing an address in the request to entries in each of a plurality of tracking structures; and
if the address matches an entry in one or more of the plurality of tracking structures, generating an indication of a conflict.

5. The method of claim 4 wherein each conflicting entry in of the plurality of tracking structures corresponds to a common entry in the table.

6. The method of claim 4 further comprising if the address does not match an entry in one or more of the plurality of tracking structures, generating an indication of no conflict.

7. An apparatus comprising:
a plurality of point-to-point interfaces to transmit data to and receive data from components within an electronic system;
a plurality of tracking structures within one or more memory components of the electronic system, each of the tracking structures coupled with and corresponding to one of the point-to-point interfaces, each of the tracking structures to generate an entry in response to detecting a data request received via the corresponding point-to-point interface;
a comparator coupled with the one or more memory components to compare addresses of multiple entries in the tracking structures to determine whether conflicting entries exist; and
an active address table coupled with the one or memory components to generate an entry for each data request stored in the tracking structures, the active address table entries to be used to resolve conflicting requests for data according to a cache coherency protocol when conflicting requests have been detected.

8. The apparatus of claim 7 wherein the data request comprises a data read request.

9. The apparatus of claim 7 wherein the data request comprises a data write request.

10. The apparatus of claim 7 wherein the active address table is associated with a memory to store a non-cached block of data associated with an address within a range corresponding to the memory.

11. The apparatus of claim 7 wherein resolving the conflicting requests according to the cache coherency protocol comprises monitoring messages associated with the conflicting requests via the active address table until the conflicting requests have been resolved.

12. A system comprising:
a plurality of point-to-point interfaces to transmit data to and receive data from components within an electronic system;
a plurality of tracking structures within one or more memory components of the electronic system, each of the tracking structures coupled with and corresponding to one of the point-to-point interfaces, each of the tracking structures to generate an entry in response to detecting a data request received via the corresponding point-to-point interface;
a comparator coupled with the one or more memory components to compare addresses of multiple entries in the tracking structures to determine whether conflicting entries exist;
an active address table coupled with the one or memory components to generate an entry for each data request stored in the tracking structures, the active address table entries to be used to resolve conflicting requests for data according to a cache coherency protocol when conflicting requests have been detected; and
a dynamic random access memory coupled with the active address table.

13. The system of claim 12 wherein the data request comprises a data read request.

14. The system of claim 12 wherein the data request comprises a data write request.

15. The system of claim 12 wherein the active address table is associated with the dynamic random access memory to store a non-cached block of data associated with an address within a range corresponding to the memory.

16. The system of claim 12 wherein resolving the conflicting requests according to the cache coherency protocol comprises monitoring messages associated with the conflicting request via the active address table until the conflicting request have been resolved.
